(19) United States
(12) Patent Application Publication
(10) Pub. No.: US 2019/0115856 A1
(43) Pub. Date: Apr. 18, 2019

(54) MOTOR CONTROL SYSTEM, MANIPULATOR SYSTEM, AND MOTOR CONTROL METHOD

(71) Applicant: Olympus Corporation, Tokyo (JP)

(72) Inventor: Kyohei Kurihara, Tokyo (JP)

(73) Assignee: Olympus Corporation, Tokyo (JP)

(21) Appl. No.: 16/216,267

(22) Filed: Dec. 11, 2018

Related U.S. Application Data
(63) Continuation of application No. PCT/JP2017/010669, filed on Mar. 16, 2017.

(51) Int. Cl. H02P 6/12; H02P 6/16; H02P 6/28

(52) U.S. Cl. CPC H02P 6/12; H02P 6/28; H02P 6/16

(57) ABSTRACT

A motor control system is used to detect a failure of an encoder without the arrangement of a dedicated sensor. The motor control system includes an electric motor, a position detection unit that detects a rotational angle position (n) of the electric motor. A current control unit that controls a current value (I) is supplied to the electric motor. A current detection unit detects the current value (I) supplied to the electric motor. A current fluctuation determination unit determines whether or not there is a change in the detected current value (I), a position fluctuation determination unit that determines whether or not there is a change in the detected rotational angle position(n), and a failure determination unit that determines that there is a failure in the position detection unit if the current value (I) is changed and the rotational angle position (n) is remained unchanged.

### CROSS-REFERENCE TO RELATED APPLICATION

This application is a continuation application of PCT Application No. PCT/JP2017/010669 filed on Mar. 16, 2017, which is hereby incorporated by reference in its entirety.

### TECHNICAL FIELD

The present disclosure relates to a manipulator system having a motor control system, and a motor control method.

### DESCRIPTION OF THE RELATED ART

Encoder failure in an electric motor is one of the most common failure of various mechanical damage, including due to mechanical vibration, collision, shock, wear and other factors caused by the internal components of the encoder structure (encoder, shaft and bearing and etc.) hardware damage. Therefore, for the detection of a failure of an encoder installed on an electric motor to detect the rotational angle position of the electric motor, it is customary to add another encoder or another sensor such as a potentiometer as for example, disclosed in the Japanese Patent No. 5855423.

However, the method of Japanese Patent No. 5855423 involves the inconvenience of high cost, because it adds another sensor for the sole purpose of detecting a failure of the encoder. Further, the arrangement of a dedicated sensor for the detection of a failure of encoder and/or the like leads to the inconvenience that a device increases in size, when there is a limited space available for the arrangement of the sensor as in a medical manipulator.

Accordingly, there is a need for a manipulator system having a motor control system and a motor control method, which can detect a failure of an encoder without arrangement of any dedicated sensor.

### BRIEF SUMMARY OF EMBODIMENTS

Embodiments of the technology disclosed herein is directed to a motor control system comprises an electric motor having an encoder and a control unit configured to be in electrical communication with the motor. The control unit electrically communicates with a position detection unit configured to detect a rotational angle position of the electric motor and a current control unit that configured to control a current value, which is supplied to the motor, based on the rotational angle position detected by the position detection unit. A current detection unit is configured to detect the current value supplied to the motor by the current control unit. A current fluctuation determination unit is configured to determine whether or not there is a change in the current value detected by the current detection unit. A position fluctuation determination unit is configured to determine whether or not there is a change in the rotational angle position detected by the position detection unit. A failure determination unit is configured to determine that there is a failure in the position detection unit if the current value has changed and the rotational angle position is remained unchanged.

In the second embodiment, a motor control system comprises an electric motor, an encoder configured to detect a rotational angle position of the motor, a sensor configured to detect a current value supplied to the motor, a processor configured to perform a computation to control the electric motor, and a memory configured to store the detected rotational angle position and the current value. Moreover, the processor is configured to calculate the current value, which is supplied to the electric motor, based on the detected rotational angle position. The processor is further configured to determine whether or not there is a change in the stored current value and determine whether or not there is a change in the stored rotational angle position. The processor is then configured to determine that there is a failure in the encoder if the current value is changed and the rotational angle position is remained unchanged.

In the third embodiment, a manipulator system comprises the motor control system, an electrically-driven manipulator configured to be driven by the electric motor, and an operation unit configured to input an operation input or command to actuate the manipulator. The operation unit may be defined as a display panel with various buttons to communicate with the motor control system.

In the fourth embodiment, a motor control method of operation comprising a position detection step of detecting a rotational angle position of a electric motor, a current detection step of detecting a current value supplied to the electric motor, a current fluctuation determination step of determining whether or not there is a change in the detected current value, a position fluctuation determination step of determining whether or not there is a change in the detected rotational angle position, and a failure determination step of determining that there is a failure in the position detection step if the current value is changed and the rotational angle position is remained unchanged.

In the fifth embodiment, a motor control system comprising an electric motor, a position detection unit, a current control unit, a current detection unit, a current fluctuation determination unit, a position fluctuation determination unit, and a failure determination unit. The position detection unit is configured to detect a rotational angle position of the electric motor. The current control unit is configured to control a current value supplied to the electric motor, based on the rotational angle position detected by the position detection unit. The current detection unit is configured to detect the current value supplied to the electric motor by the current control unit. The current fluctuation determination unit is configured to determine whether or not there is a change in the current value detected by the current detection unit. The position fluctuation determination unit is configured to determine whether or not there is a change in the rotational angle position detected by the position detection unit. The failure determination unit is configured to determine that there is a failure in the current detection unit if the rotational angle position is changed and the current value is remained unchanged.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram illustrating a manipulator system according to a first embodiment of the system and method described herein.

FIG. 2 is a block diagram of a failure detection unit included in an electric motor control system in the manipulator system of FIG. 1.

FIG. 3 is a flow chart describing the operation of the manipulator system of FIG. 1.

FIG. 4 is a graph illustrating a first example in which a failure is detected in neither an encoder nor a current detection unit.

FIG. 5 is a graph illustrating a second example in which a failure is detected in neither the encoder nor the current detection unit.

FIG. 6 is a graph illustrating a third example in which a failure is detected in neither the encoder nor the current detection unit.

FIG. 7 is a graph illustrating a fourth example in which a failure is detected in neither the encoder nor the current detection unit.

FIG. 8 is a graph illustrating an example in which a failure is detected in the current detection unit.

FIG. 9 is a graph illustrating an example in which a failure is detected in the encoder.

FIG. 10 is a block diagram illustrating a modification of the manipulator system of FIG. 1.

### DETAILED DESCRIPTION OF THE EMBODIMENTS

Embodiments of the technology disclosed herein is directed to a motor control system comprises an electric motor having an encoder and a control unit configured to be in electrical communication with the electric motor. The control unit electrically communicates with a position detection unit that detects a rotational angle position of the electric motor and a current control unit that controls a current value, which is supplied to the electric motor, based on the rotational angle position detected by the position detection unit. A current detection unit detects the current value supplied to the electric motor by the current control unit. A current fluctuation determination unit determines whether or not there is a change in the current value detected by the current detection unit. A position fluctuation determination unit determines whether or not there is a change in the rotational angle position detected by the position detection unit. A failure determination unit determines that there is a failure in the position detection unit if the current value has changed and the rotational angle position is remained unchanged.

According to a first embodiment, when the electric motor is running based on a target angle position instruction signal, a rotational angle position is detected by the position detection unit. A current value that is supplied to the electric motor, is controlled by the current control unit based on the detected rotational angle position to rotate the electric motor. It should be noted that the current value used for the control is detected by the current detection unit.

Then, it is determined by the current fluctuation determination unit whether or not the current value detected by the current detection unit has changed, and it is determined by the position fluctuation determination unit whether or not the rotational angle position has changed. If the current value is changed and the rotational angle position is remained unchanged, it is meant that the detection of the rotational angle position is not performed even though the electric motor was in operation. Therefore, it is possible to determine by the failure determination unit that there is a failure in the position detection unit.

Hence, a failure of the position detection unit is determined without arrangement of any dedicated sensor, since the use of the current detection unit is provided for use in controlling the electric motor.

The failure determination unit may determine that there is a failure in the current detection unit if the rotational angle position is changed and the current value is remained unchanged.

When configured as described herein, if the rotational angle position is changed and the current value is remained unchanged, then it is meant that the current value does not change even though the electric motor is running. Therefore, it is possible to determine by the failure determination unit that there is a failure in the current detection unit. Hence, according to this embodiment, the failure of the current detection unit is determined using a detection resulted from the position detection unit.

In the above-described first embodiment, the electric motor may be a brushed direct current motor.

When configured as described herein, if the electric motor is running, the current value fluctuates by fluctuations in resistance value depending on the states of contact between brushes and a commutator. It is, therefore, possible to easily detect the changes in the current value that the electric motor is running.

The failure determination unit may be provided with a notification unit that notifies or alert the failure to the operator so that a correction action can be taken to rectify the problem.

In the second embodiment, a motor control system comprises an electric motor, an encoder that detects a rotational angle position of the electric motor, a sensor that detects a current value supplied to the electric motor, a processor that performs a computation to control the electric motor, and a memory that stores the detected rotational angle position and the current value. Moreover, the processor calculates the current value, which is supplied to the electric motor, based on the detected rotational angle position. The processor further determines whether or not there is a change in the stored current value and determines whether or not there is a change in the stored rotational angle position. The processor then determines that there is a failure in the encoder if the current value is changed and the rotational angle position is remained unchanged.

Moreover, when the electric motor is running, the rotational angle position is detected by the encoder, and a current value that is supplied to the electric motor, is controlled by the processor or CPU based on the detected rotational angle position to rotate the electric motor. Here, the current value used for the controlling the electric motor is detected by the sensor. Then, it is determined whether or not the current value stored in the memory has changed, and it is determined by the processor or CPU whether or not the rotational angle position has changed. If by the processor, the current value is changed and the rotational angle position is remained unchanged, it is meant that the detection of the rotational angle position is not performed even though the electric motor was in operation. Therefore, it is possible to determine that there is a failure in the encoder. Furthermore, the processor may determine that there is a failure in the sensor if the rotational angle position is changed and the current value is remained unchanged. It should be appreciated by one of ordinary skill in the art that various electric motors may be used and one of the electric motor that can be used with the technology disclosed herein is a brushed direct current motor. One of the advantages of the technology disclosed herein is that the processor may be configured to notify or alert the operator or user when there is a failure accordingly.

In the third embodiment, a manipulator system comprises a motor control system, an electrically-driven manipulator that is driven by the electric motor, and an operation unit that inputs an operation input or command to actuate the manipulator. The operation unit may be defined as a display panel with various buttons to communicate with the motor control system.

In accordance with the disclosed technology herein, it is no longer necessary to provide the manipulator with a dedicated sensor for the detection of a failure in the position detection unit. Another advantage of the technology disclosed herein is that a failure of the position detection unit is detected without increasing the manipulator in size.

In the fourth embodiment, a motor control method of operation comprising a position detection step of detecting a rotational angle position of an electric motor, a current detection step of detecting a current value supplied to the electric motor, a current fluctuation determination step of determining whether or not there is a change in the detected current value, a position fluctuation determination step of determining whether or not there is a change in the detected rotational angle position, and a failure determination step of determining that there is a failure in the position detection step if the current value is changed and the rotational angle position is remained unchanged. The rotational angle position of the electric motor and the current value are detected in the position detection step and the current detection step. Then, it is determined in the current fluctuation determination step whether or not the detected current value is changed, and it is determined in the position fluctuation determination step whether or not the detected rotational angle position is changed. If the current value is changed and the rotational angle position is remained unchanged, it is meant that the detection of the rotational angle position is not performed even though the electric motor is in operation. Therefore, it is possible to determine in the failure determination step that there is a failure in the position detection step. The failure determination step may determine that there is a failure in the current detection step if the rotational angle position is changed and the current value is remained unchanged. In addition, if the current value is remained unchanged and the rotational angle position is changed, then it is meant that the detection of the rotational angle position is performed even though the electric motor is not in operation or running. Therefore, it is possible to determine in the failure determination step that there is a failure in the current detection step. As described hereinabove, one of the advantages of the technology disclosed herein is that a failure of an encoder can be detected without arrangement of any dedicated sensor.

With reference to the drawings, a description will hereinafter be made about a motor control system 20 according to the first embodiment of the technology disclosed herein and a manipulator system 1 according to the third embodiment of the technology disclosed herein.

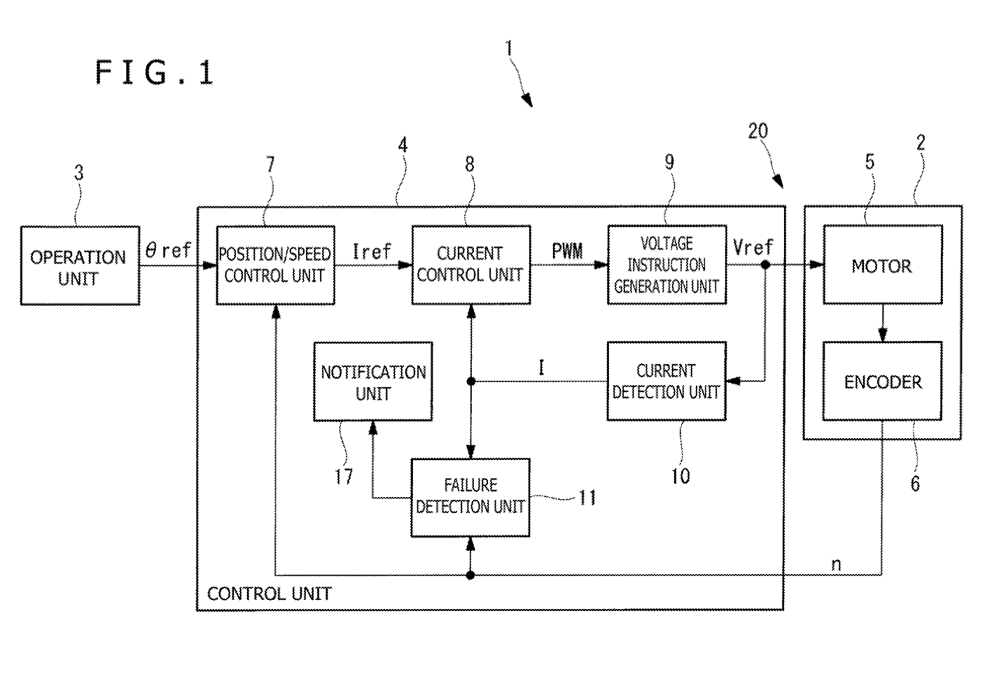

As illustrated in FIG. 1, the manipulator system 1 comprises a medical manipulator 2 inserted into a subject or a body to treat an affected part, an operation unit 3 operated by an operator, and a control unit 4 configured to controls the manipulator 2 based on an operation input inputted at the operation unit 3.

The manipulator 2 is an electrically-driven device driven by an electric motor 5, and is configured so that the manipulator 2 is actuated to a desired position by rotation of the electric motor 5 based on a voltage instruction Vref from the control unit 4. Further, the manipulator 2 is provided with an encoder (position detection unit) 6 that detects a rotational angle position n of the electric motor 5.

Without any limitation to type of electric motor, the electric motor 5 is a brushed direct current (DC) motor.

The operation unit 3 is configured to input a target rotational angle position θ_{ref} for the electric motor 5 of the manipulator 2 according to an operation input such as an amount of rotation of a wheel (not illustrated) operated by the operator or user of the device.

The control unit 4 includes a position/speed control unit 7, a current control unit 8, a voltage instruction generation unit 9, and a current detection unit 10. The position/speed control unit 7 generates a target current instruction I_{ref} based on the difference between the target rotational angle position θ_{ref} inputted at the operation unit 3 and the rotational angle position n of the electric motor 5 as detected by the encoder 6. The current control unit 8 outputs a voltage control signal, such as pulse-width modulation signal (aka, PWM control signal) according to the generated target current instruction I_{ref}. The voltage instruction generation unit 9 generates a voltage instruction V_{ref}, which is inputted to the electric motor 5, according to the outputted voltage control signal PWM. The current detection unit 10 is a sensor that detects a current value I flowing to the electric motor 5 according to the generated voltage instruction Vref.

The control unit 4 further includes a failure detection unit 11 that detects any failure in the encoder 6 or the current detection unit 10 based on the rotational angle position n detected by the encoder 6 and the current value I detected by the current detection unit 10.

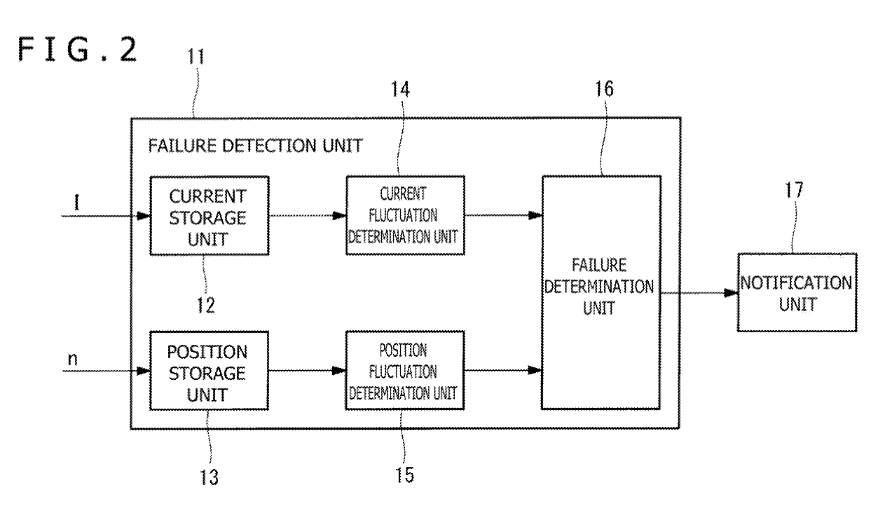

As illustrated in FIG. 2, the failure detection unit 11 includes a current storage unit 12 that stores, over a predetermined time, current values I detected by the current detection unit 10, and a position storage unit 13 that stores, over the predetermined time, rotational angle positions n detected by the encoder 6.

The failure detection unit 11 further includes a current fluctuation determination unit 14 that determines any change in current value I with reference to the current values (I) stored over the predetermined time in the current storage unit 12, and a position fluctuation determination unit 15 that determines any change in rotational angle position n with reference to the rotational angle positions n stored over the predetermined time in the position storage unit 13.

Herein, the predetermined time can be, for example, a period of time required for a shaft of the electric motor 5 to rotate over 45° at a lowest speed if an electrode of a commutator is divided in a circumferential direction into eight segments. When the electric motor 5 is running, the current value I, therefore, fluctuates at least once in the time-series data by a fluctuation in resistance value under the positional relationship between brushes and the commutator.

The failure detection unit 11 also includes a failure determination unit 16 that determines any failure based on determination results by the current fluctuation determination unit 14 and the position fluctuation determination unit 15.

The failure determination unit 16 is configured to determine that there is a failure in the encoder 6 if the rotational angle position n is remained unchanged and the current value I is changed. Moreover, the failure determination unit 16 is also configured to determine that there is a failure in the current detection unit 10 if the rotational angle position n is changed and the current value I is remained unchanged.

The control unit 4 further includes a notification unit 17 that, if determined by the failure determination unit 16 that there is a failure in the encoder 6 or the current detection unit 10, notifies or alert the operator or user accordingly. As the manner of the notification, it is possible to adopt a desired manner such as a display on a monitor, an alarm sound, or vibrations.

The motor control system 20 is configured of the electric motor 5, the encoder 6 and the control unit 4. A description will hereinafter be made about operations of the motor control system 20 and the manipulator system 1 according to the embodiments.

In use, to treat an affected part of a patient by using the manipulator system 1 of this embodiment, the manipulator 2 is inserted into the body of the patient, and the operation unit 3 is operated to actuate the manipulator 2 so that the affected part is treated by the manipulator 2. Specifically, when the operator operates the operation unit 3, a target rotational angle position θ_{ref} commensurate to an operation input is inputted, and based on the difference between the inputted target rotational angle position θ_{ref} and a rotational angle position n of the electric motor 5 as detected by the encoder 6, a target current instruction I_{ref} is generated by the position/speed control unit 7. The generated target current instruction I_{ref} is inputted to the current control unit 8, and a voltage control signal PWM commensurate to the target current instruction Iref is outputted. Then, a voltage instruction V_{ref} commensurate to the outputted voltage control signal PWM is generated by the voltage instruction generation unit 9, and is supplied to the electric motor 5.

The voltage instruction V_{ref} generated by the voltage instruction generation unit 9 is detected by the current detection unit 10, and is used at the current control unit 8 to calculate a difference from the target current instruction I_{ref}. The voltage control signal PWM is controlled by the current control unit 8 so that the difference becomes smaller.

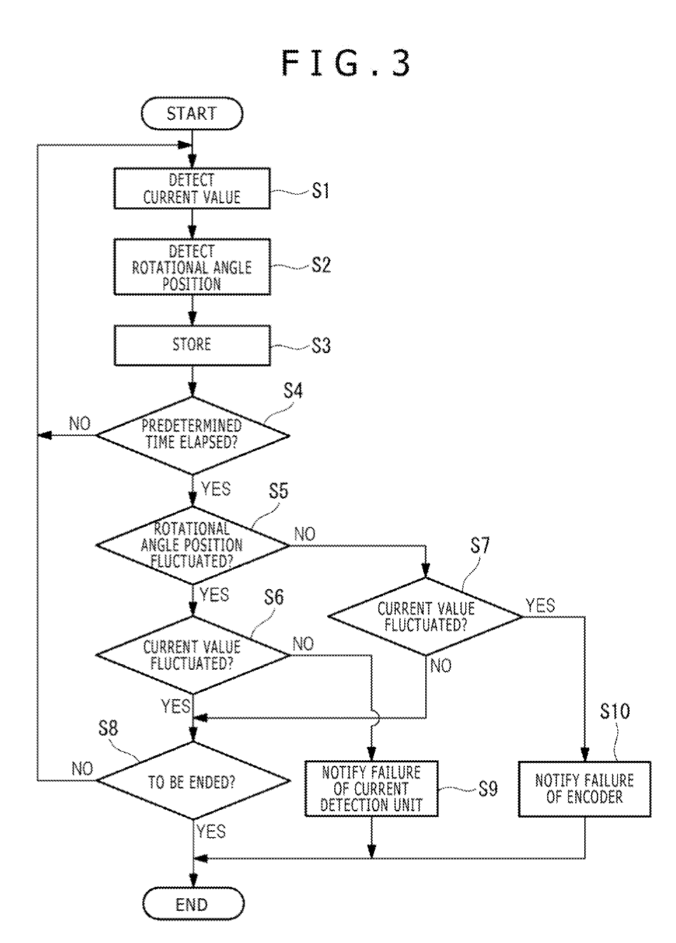

A description will hereinafter be described about a motor control method. According to the motor control method, as illustrated in FIG. 3, the detection of a current value (I) by the current detection unit 10 (current detection step S1) and the detection of a rotational angle position n by the encoder 6 (position detection step S2) are regularly performed. And the detected current values (I) and the rotational angle positions n are delivered to the current storage unit 12 and the position storage unit 13 in the failure detection unit 11 and are stored as pieces of time-series data over a predetermined time (steps S3 and S4). If the predetermined time has not elapsed yet, the steps from step S1 are repeated.

Then, at every elapse of the predetermined time, using the time-series data of the rotational angle positions n of the electric motor 5 as detected by the encoder 6 and stored in the position storage unit 13, it is determined by the position fluctuation determination unit 15 whether or not there has been a change in the rotational angle position n of the electric motor 5 (position fluctuation determination step S5).

Next, irrespective of whether or not there is a change in the rotational angle position n of the electric motor 5, using the time-series data of the current value I to the electric motor 5 as detected by the current detection unit 10 and stored in the current storage unit 12, it is determined by the current fluctuation determination unit 14 whether or not there has been a change in the current value I to the electric motor 5 (current fluctuation determination steps S6 and S7).

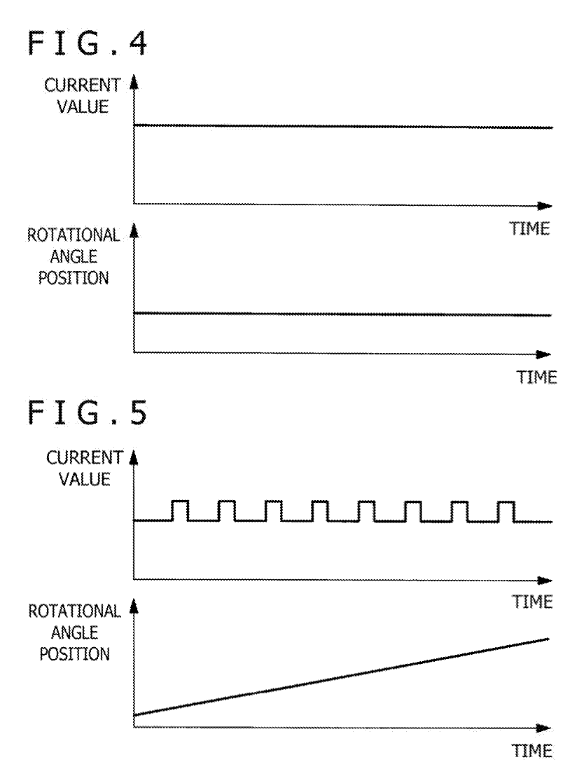

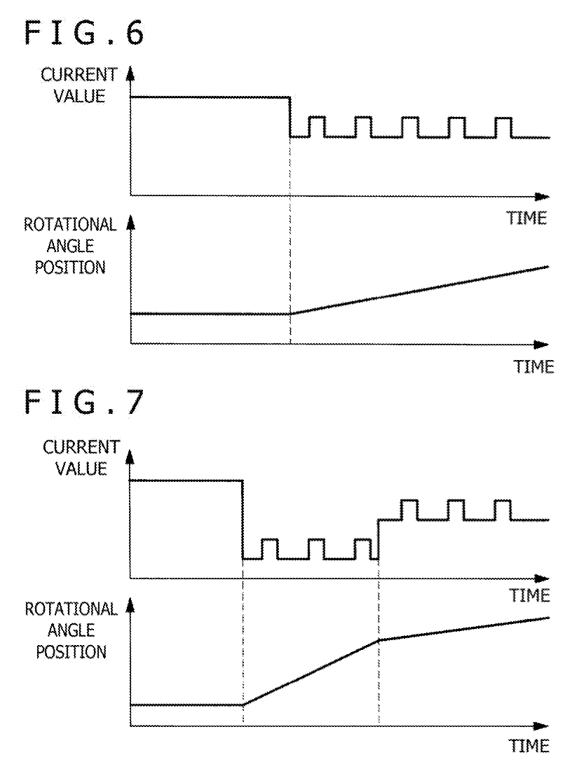

As illustrated in FIG. 4, If there has been no change in the rotational angle position n of the electric motor 5 and there has been no change either in the current value (I) or as illustrated in FIG. 5, if there has been a change in the rotational angle position n of the electric motor 5 and there has also been a change in the current value I, it is determined at the failure determination unit 16 that no failure exists (step S8), and the steps from step S1 are repeated. In the cases of FIG. 6 and FIG. 7, it is similarly determined that no failure exists. Furthermore, even if no failure exists, the processing is ended if a predetermined condition (for example, actuation stop or the like of the manipulator 2) is determined to have been met (step S8).

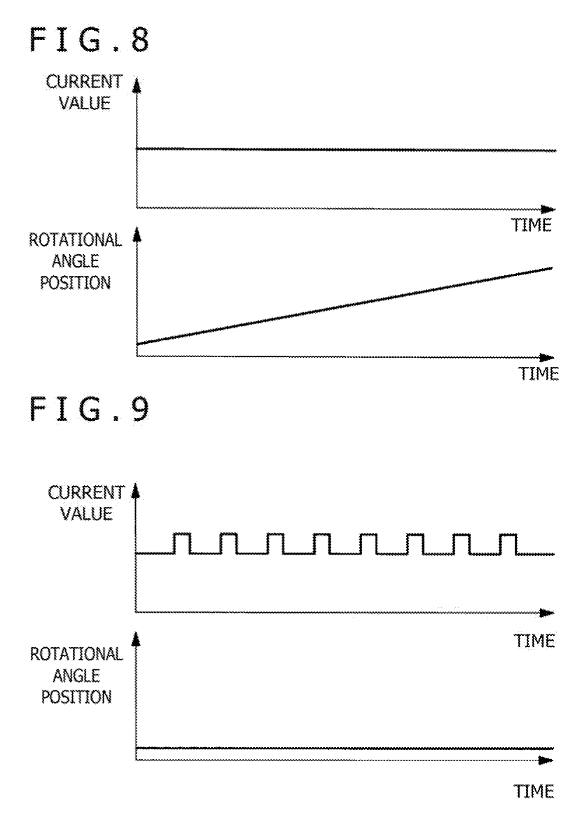

On the other hand, as illustrated in FIG. 8, if there has been a change in the rotational angle position n of the electric motor 5 and there has been no change in the current value I, it is determined at the failure determination unit 16 that there is a failure in the current detection unit 10, and by the notification unit 17, a notification is made accordingly (failure determination step S9). If notified by the notification unit 17, the processing is ended.

As illustrated in FIG. 9, if there has been no change in the rotational angle position n of the electric motor 5 and there has been a change in the current value I, it is determined at the failure determination unit 16 that there is a failure in the encoder 6, and by the notification unit 17, a notification is made accordingly (failure determination step S10). If notified by the notification unit 17, the processing is ended.

According to the motor control system 20 and the manipulator system 1 of these embodiments, a failure of the encoder 6 is detected using a current value (I), which is detected to control the electric motor 5, as described hereinabove. It is, therefore, unnecessary to arrange any dedicated sensor for the detection of a failure of the encoder 6. Hence, there are advantageous effects in that the manufacturing cost is reduced and the manipulator 2 is prevented from increasing in size.

According to the motor control system 20 and the manipulator system 1 of these embodiments, it is also possible to determine a failure of the current detection unit 10 by using a detection result from the encoder 6.

In these embodiments, the brushed DC motor is exemplified as the electric motor 5. Consequently, there are two resistance values owing to the relative positional relationship between the brushes and the commutator. Hence, rotation of the electric motor 5 can be easily detected based on fluctuations in the current value (I) as caused by fluctuations in resistance value.

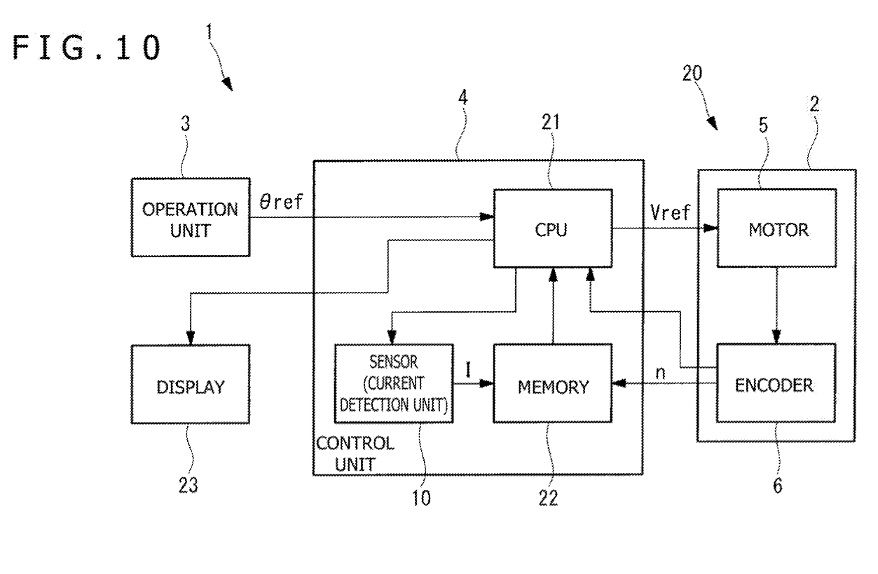

In these embodiments, as the control unit 4, there is exemplified one that uses the position/speed control unit 7, the current control unit 8, the voltage instruction generation unit 9, the failure detection unit 11 and the notification unit 17. Instead of such a control unit, as illustrated in FIG. 10, it is possible to use an alternative control unit including a CPU (processor) 21, which performs the generation of a target current instruction I_{ref}, the determination of a failure, and the notification of the failure.

In this modification, the control unit 4 is configured of the current detection unit 10, a memory 22 that stores current values I and rotational angle positions n detected by the current detection unit 10 and the encoder 6, and the CPU 21.

The CPU 21 generates a target current instruction I_{ref} based on the difference between a target rotational angle position θ_{ref} inputted at the operation unit 3 and a rotational angle position n of the electric motor 5 as detected by the encoder 6, and generates a voltage instruction V_{ref}, which is inputted to the electric motor 5, according to the generated target current instruction I_{ref}.

Furthermore, the CPU 21 is configured to determine any change in current value I with reference to the current values (I) stored in the memory 22 and any change in rotational angle position n with reference to the rotational angle positions n stored in the memory 22, and to determine, based on these determinations, whether or not there is any failure in the current detection unit 10 or the encoder 6. If determined that there is a failure, the CPU 21 notifies accordingly. In FIG. 10, numeral 23 designates a display to which information of the failure notified from the CPU 21 is outputted.

The control unit 4 may include a plurality of CPUs as the CPU 21, and may also include a plurality of memories as the memory 22.

In each of these embodiments and the modification, as the control unit 4, one that is configured in a single housing is exemplified. The control unit 4 is, however, not limited to such a configuration. For example, with brushless electric motor the control unit 4 can be part of the motor.

In each of these embodiments and the modification, from the operation unit 3 to the control unit 4, electrical signals may be delivered through wiring such as a cable, or wirelessly by using a transmission unit and a reception unit or the like.

In sum, one aspect of the disclosed technology herein is directed to a motor control system comprises an electric motor. A position detection unit is configured to detect a rotational angle position of the electric motor. A current control unit is configured to control a current value supplied to the electric motor based on the rotational angle position detected by the position detection unit. A current detection unit is configured to detect the current value supplied to the electric motor by the current control unit. A current fluctuation determination unit is configured to determine whether or not there is a change in the current value detected by the current detection unit. A position fluctuation determination unit is configured to determine whether or not there is a change in the rotational angle position detected by the position detection unit. A failure determination unit is configured to determine that there is a failure in the position detection unit if the current value is changed and the rotational angle position is remained unchanged. The failure determination unit is configured to determine that there is a failure in the current detection unit if the rotational angle position is changed and the current value is remained unchanged. The failure determination unit includes a notification unit that, if the failure is determined, notifies accordingly. Finally, the electric motor is a brushed direct current motor.

Another aspect of the disclosed technology is directed to a motor control system comprises an electric motor. An encoder is configured to detect a rotational angle position of the electric motor. A sensor is configured to detect a current value supplied to the electric motor. A processor is configured to perform a computation to control the electric motor. A memory is configured to store the detected rotational angle position and the current value. The processor is configured: to calculate the current value, which is supplied to the electric motor, based on the detected rotational angle position, determine whether or not there is a change in the stored current value, determine whether or not there is a change in the stored rotational angle position, and determine that there is a failure in the encoder if the current value is changed and the rotational angle position is remained unchanged.

The processor is configured to determine that there is a failure in the sensor if the rotational angle position is changed and the current value is remained unchanged. The processor is configured so that, if the failure is determined, the processor is configured to notify accordingly.

A further aspect of the disclosed technology is directed to a manipulator system comprises a motor control system. An electrically-driven manipulator is configured to be in electrical communication with the motor control system and an operation is configured to actuate the manipulator.

A further aspect of the disclosed technology is directed to A motor control method having a position detection step of detecting a rotational angle position of an electric motor; a current detection step of detecting a current value supplied to the electric motor; a current fluctuation determination step of determining whether or not there is a change in the detected current value; a position fluctuation determination step of determining whether or not there is a change in the detected rotational angle position; and a failure determination step of determining that there is a failure in the position detection step if the current value is changed and the rotational angle position is remained unchanged.

A further aspect of the disclosed technology is directed to a motor control system comprises an electric motor. A position detection unit is configured to detect a rotational angle position of the electric motor. A current control unit is configured to control a current value supplied to the electric motor based on the rotational angle position detected by the position detection unit. A current detection unit is configured to detect the current value supplied to the electric motor by the current control unit. A current fluctuation determination unit is configured to determine whether or not there is a change in the current value detected by the current detection unit. A position fluctuation determination unit is configured to determine whether or not there is a change in the rotational angle position detected by the position detection unit. A failure determination unit is configured to determine that there is a failure in the current detection unit if the rotational angle position is changed and the current value is remained unchanged. The failure determination unit is configured to determine that there is a failure in the position detection unit if the current value is changed and the rotational angle position is remained unchanged.

While various embodiments of the disclosed technology have been described above, it should be understood that they have been presented by way of example only, and not of limitation. Likewise, the various diagrams may depict an example schematic or other configuration for the disclosed technology, which is done to aid in understanding the features and functionality that can be included in the disclosed technology. The disclosed technology is not restricted to the illustrated example schematic or configurations, but the desired features can be implemented using a variety of alternative illustrations and configurations. Indeed, it will be apparent to one of skill in the art how alternative functional, logical or physical locations and configurations can be implemented to implement the desired features of the technology disclosed herein.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one”, “one or more” or the like; and adjectives such as “conventional”, “traditional”, “normal”, “standard”, “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more”, “at least”, “but not limited to” or other like phrases in some instances shall not be read to mean that the narrower case is intended or required in instances where such broadening phrases may be absent. Additionally, the various embodiments set forth herein are described in terms of exemplary schematics, block diagrams, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular configuration.

What is claimed is:

1. A motor control system comprising:
an electric motor;
a position detection unit configured to detect a rotational angle position of the electric motor;
a current control unit configured to control a current value supplied to the electric motor, based on the rotational angle position detected by the position detection unit;
a current detection unit configured to detect the current value supplied to the electric motor by the current control unit;
a current fluctuation determination unit configured to determine whether or not there is a change in the current value detected by the current detection unit;
a position fluctuation determination unit configured to determine whether or not there is a change in the rotational angle position detected by the position detection unit; and
a failure determination unit configured to determine that there is a failure in the position detection unit if the current value is changed and the rotational angle position is remained unchanged.

2. The motor control system according to claim 1, wherein the failure determination unit is configured to determine that there is a failure in the current detection unit if the rotational angle position is changed and the current value is remained unchanged.

3. The motor control system according to claim 1, wherein the electric motor is a brushed direct current motor.

4. The motor control system according to claim 1, wherein the failure determination unit includes a notification unit that, if the failure is determined, notifies accordingly.

5. A motor control system comprising:
an electric motor;
an encoder configured to detect a rotational angle position of the electric motor;
a sensor configured to detect a current value supplied to the electric motor;
a processor configured to perform a computation to control the electric motor; and
a memory configured to store the detected rotational angle position and the current value,
wherein the processor is configured to:
calculate the current value, which is supplied to the electric motor, based on the detected rotational angle position,
determine whether or not there is a change in the stored current value,
determine whether or not there is a change in the stored rotational angle position, and
determine that there is a failure in the encoder if the current value is changed and the rotational angle position is remained unchanged.

6. The motor control system according to claim 5, wherein the processor is configured to determine that there is a failure in the sensor if the rotational angle position is changed and the current value is remained unchanged.

7. The motor control system according to claim 5, wherein the electric motor is a brushed direct current motor.

8. The motor control system according to claim 5, wherein the processor is configured so that, if the failure is determined, the processor is configured to notify accordingly.

9. A manipulator system comprising:
a motor control system;
an electrically-driven manipulator configured to be in electrical communication with the motor control system; and
an operation configured to actuate the manipulator.

10. A motor control method comprising:
a position detection step of detecting a rotational angle position of an electric motor;
a current detection step of detecting a current value supplied to the electric motor;
a current fluctuation determination step of determining whether or not there is a change in the detected current value;
a position fluctuation determination step of determining whether or not there is a change in the detected rotational angle position; and
a failure determination step of determining that there is a failure in the position detection step if the current value is changed and the rotational angle position is remained unchanged.

11. The motor control method according to claim 10, wherein the failure determination step determines that there is a failure in the current detection step if the rotational angle position is changed and the current value is remained unchanged.

12. A motor control system comprising:
an electric motor;
a position detection unit configured to detect a rotational angle position of the electric motor;
a current control unit configured to control a current value supplied to the electric motor, based on the rotational angle position detected by the position detection unit;
a current detection unit configured to detect the current value supplied to the electric motor by the current control unit;
a current fluctuation determination unit configured to determine whether or not there is a change in the current value detected by the current detection unit;
a position fluctuation determination unit configured to determine whether or not there is a change in the rotational angle position detected by the position detection unit; and
a failure determination unit configured to determine that there is a failure in the current detection unit if the rotational angle position is changed and the current value is remained unchanged.

13. The motor control system according to claim 12, wherein the failure determination unit is configured to determine that there is a failure in the position detection unit if the current value is changed and the rotational angle position is remained unchanged.
